(19) United States
(12) Patent Application Publication
(10) Pub. No.: US 2024/0008687 A1
(43) Pub. Date: Jan. 11, 2024

(54) Apparatus for Creating and Dispensing Whipped Food Products

(71) Applicant: Columbia Insurance Company, Omaha, NE (US)

(72) Inventors: Michael Mastroianni, Addison, IL (US); Kat Reiser, Addison, IL (US); Zach Wilson, Addison, IL (US); Maurice Luo, Addison, IL (US); Kendra Kelly, Addison, IL (US); Megan Hemme, Addison, IL (US)

(21) Appl. No.: 18/219,044

(22) Filed: Jul. 6, 2023

Related U.S. Application Data
(60) Provisional application No. 63/358,737, filed on Jul. 6, 2022.

(51) Int. Cl. A47J 43/07; A47J 43/044; A47J 43/10

(52) U.S. Cl. CPC A47J 43/0711; A47J 43/044; A47J 43/1018; A47J 2043/04427

(57) ABSTRACT

A whipping and dispensing appliance is disclosed for use in the preparation of food products. The whipping and dispensing appliance may have a housing and a plurality of different caps so that it can transition between modes of operation. In a first mode of operation, the whipping and dispensing appliance can create a whipped food product. In a second mode of operation, the whipping and dispensing appliance can store the whipped food product, and in a third mode of operation the whipping and dispensing appliance can dispense the food product. The whipping and dispensing appliance may have multiple mixing elements to create the whipped food product and a plunger disc to help a plunger dispense the whipped food from the interior of the housing.

### CROSS-REFERENCE AND PRIORITY CLAIM TO RELATED PATENT APPLICATIONS

This US non-provisional patent application claims priority to U.S. provisional patent application 63/358,737, filed Jul. 6, 2022, and titled “Apparatus for Creating and Dispensing Whipped Food Products”, the entire disclosure of which is incorporated herein by reference.

### INTRODUCTION

Kitchen appliances come in many different forms and most kitchen appliances are suitable only for a single use. For example, if a user wished to have an appliance for chopping nuts, the user would have to buy an individual appliance solely for the purpose of chopping nuts. If the user then wished to have an appliance for blending purposes, the nut chopper appliance would be inadequate, and the user would have to purchase another appliance solely for the purpose of blending. The number of single use designed appliances available and purchased by consumers is extremely vast. Moreover, this process of purchasing and using single use appliances becomes time consuming, expensive, and a waste of kitchen space. What is needed is a household appliance that can replace some of these single use appliances while also providing functional value to the end user.

Within the kitchen space, many applications require the whipping of food items to create the desired food product end results. Egg whites for example are whipped into a meringue so that they can be used in baking recipes and to decorate finished food products. Another commonly used product produced by whipping is whipped cream. Generally, whipped cream can be produced by aggressively mixing, aka whipping, the cream in a bowl or container. This is usually accomplished by hand with a whisk or a standard kitchen mixer using whisk type attachments. Hand whipping can be extremely tiresome for the cook and time consuming. Using a mechanical mixer is less time consuming, but the created whipped cream is in no shape for dispensing to prepared food items or baked goods. When the cream is whipped into a light foam-like substance called whipped cream, it is rather sticky and not conducive for immediate plating. As such, handmade whipped cream must then be transferred into an additional dispensing apparatus to place the whipped cream on cakes and other food items or placed in a secondary container for storage. In both instances, the creation of freshly made whipped cream or other whipped food items requires the user to take additional steps for storage and dispensing with the use of other different single use products.

Imitation whipped cream itself is commonly dispensed through an aerosol canister. Gas can be mixed with a liquid mixture giving the sweet slurry the body and appearance of handmade whipped cream. The end result is a substance that imitates handmade whipped cream, but does not have the full body, texture, or taste of real fresh whipped cream. For handmade whipped creams, the result is a fuller flavor and texture of the freshly made product. Yet, the industry does not have any type of dispensing element created for use with the freshly made product. The whipped cream or other whipped food items must then be transferred from the mixing bowl into a secondary kitchen appliance to dispense the whipped cream onto the desired food item. This transfer process causes many issues. Firstly, some of the fresh whipped cream is left over in the mixing bowl or container and not applied to the finished food product. Secondly, as there is usually an increased time gap between the creation of the whipped cream and dispensing the whipped cream onto a food product, the whipped cream can lose some texture as the air whipped into the cream is slowly released. Thus, there is a need in the industry to create such a product where not only the whipped cream is produced in a container, but it can also be quickly dispensed with little to no loss of the produced whipped cream or other type of whipped food product.

The inventors envision such a device which can solve and address these issues in the industry. The device disclosed by the inventors not only can create a whipped food product, such as whipped cream, but the whipped food product is created quickly when compared to other known methods of whipped product production. Furthermore, the same device used to create the whipped food product can also be used to dispense and whipped food product onto the desired food items or baked goods. Finally, the whipped food product can be securely stored within the same container if the whipped food product is to be used later. The airtight container helps eliminate the texture and fullness loss of the whipped food product if it is not immediately used and helps it remain in its ideal dispensing state, that state being immediately after creation into the whipped food product, so that it can be used later with minimal textural or fullness disturbances.

Further features and advantages of the disclosed embodiments, as well as the structure and operation of various elements of the disclosed embodiments, are described in detail below with reference to the accompanying drawings.

### BRIEF DESCRIPTION OF THE DRAWINGS

The accompanying drawings, which are incorporated in and form a part of the specification, illustrate the disclosed embodiments and, together with the description, serve to explain certain inventive principles. In the drawings:

FIG. 1 illustrates an example whipping and dispensing appliance in a whipping mode of operation in accordance with an embodiment of the disclosure.

FIG. 2 illustrates an example whipping and dispensing appliance in a storage mode of operation in accordance with an embodiment of the disclosure.

FIG. 3 illustrates an example whipping and dispensing appliance in a dispensing mode of operation in embodiment of the disclosure.

FIG. 4 illustrates a cross sectional view of an example whipping and dispensing appliance in a whipping mode of operation in accordance with an embodiment of the disclosure.

FIG. 5 shows a cross sectional view of an example whipping and dispensing appliance in a dispensing mode of operation in accordance with an embodiment of the disclosure.

FIG. 6 shows an exploded view of the components of an example whipping and dispensing appliance in accordance with an embodiment of the disclosure.

FIG. 7 shows an example mixing apparatus to be used with an example whipping and dispensing appliance in a whipping and dispensing mode of operation in accordance with an embodiment of the disclosure.

FIG. 8 shows a dispensing cap to be used with an example whipping and dispensing appliance in a dispensing mode of operation in accordance with an embodiment of the disclosure.

FIG. 9 shows a whipping cap to be used with an example whipping and dispensing appliance in a dispensing and whipping mode of operation in accordance with an embodiment of the disclosure.

FIG. 10 shows a storage cap to be used with an example whipping and dispensing appliance in a storage and whipping mode of operation in accordance with an embodiment of the disclosure.

### DETAILED DESCRIPTION OF EXAMPLE EMBODIMENTS

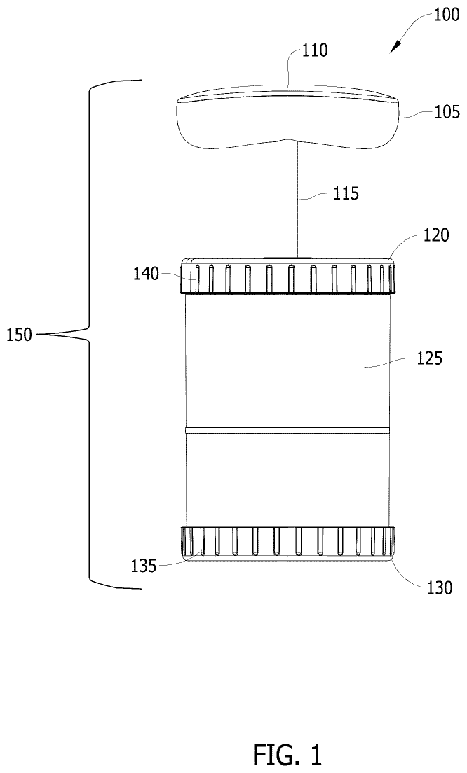

Referring to the accompanying drawings, FIG. 1 illustrates an example whipping and dispensing appliance 100. The example whipping and dispensing appliance 100 shown in FIG. 1, is viewed in a whipping mode 150 of operation. In the whipping mode 150 of operation, food ingredients can be added to the whipping and dispensing appliance 100 so that the desired whipped product can be created. Ingredients such as sugar and cream can be added to create whipped cream. In other examples, sugar and egg whites may be added to create meringues. The whipping and dispensing appliance 100 can create any desired whipped food product and additional options or food product combinations are available besides those mentioned above.

The whipping and dispensing appliance 100, has a housing 125 into which the food ingredients may be added. The housing 125 can be any type of container shape to enclose the food ingredients inside. The example embodiment shows a cylinder type housing 125, but other shapes such as square, oval, or conical are possible. The housing 125 may be made of any suitable food safe material to hold and enclose the added food ingredients during the whipping mode 150, dispensing mode, or storage mode of operation. For example, the housing 125 may be made of a food safe plastic or other polymer-based combinations. In other examples metal or metallic alloys may be used to create the housing 125. The housing 125 may be solid in color or translucent depending on the materials used, and it should be understood that additional and other functionally appropriate materials may also be used to create the housing 125.

In the whipping mode 150 of operation, the housing 125 has a storage cap 130 attachable to the housing 125. The storage cap 130 can be sized to fit the shape of the housing 125 and to mirror the desired shape of the housing 125. The storage cap 130 can be any type of covering shape to enclose the food ingredients inside and mate with the housing 125. The storage cap 130 may be made of any suitable food safe material to hold and enclose the added food ingredients during connection with the housing 125 in each the whipping mode 150, dispensing mode, or storage mode of operation. For example, the storage cap 130 may be made of a food safe plastic or other polymer-based combinations. In other examples metal or metallic alloys may be used to create the storage cap 130. The storage cap 130 may be solid in color or translucent depending on the materials used, and it should be understood that additional and other functionally appropriate materials may also be used to create the storage cap 130.

As the example housing 125 viewed in FIG. 1 is cylindrical, the storage cap 130 is a circular shape. In should be understand that other shapes such as oval or square can be used so long as the storage cap 130 can mate with the desired shape of the housing 125. The storage cap 130 can attach to the housing 125 by way of threads. Rotating the storage cap can mate the threads of the housing 125 with the threads of the storage cap 130. In such a manner, the storage cap 130 fits onto the exterior surface of the housing 125 at the housing thread location. In additional embodiments, and not viewed in FIG. 1, the storage cap 130 may also include a gasket in the interior area of the storage cap 130. The gasket may further be in communication and contact with the interior surface of the housing 125 opposite the housing threads. The gasket helps contain the food ingredients or other food items contained within the housing 125 when the whipping and dispensing appliance 100 is in either the whipping mode 150, dispensing mode, or storage mode. In each the whipping mode 150 and the dispensing mode of the whipping and dispensing appliance 100, the gasket helps prevent the food ingredients contained within the housing 125 from being forced via the applied user pressure into, up, and through the threaded connection between the housing 125 and the storage cap 130 causing leakage. In other embodiments, additional ways to fasten the storage cap 130 and the housing 125 can be used such as fastener clips, clamps, or bolts. The storage cap 130 may have a plurality of storage cap protrusions 135 extending outward from the side wall of the storage cap 135. These storage cap protrusions 135 each help the user grasp the storage cap 130 so that it can be easily tightened or removed by the user to access the interior of the housing 125 for removal of food ingredients, whipped food product, or for cleaning purposes after operational use.

On the other end of the housing 125, a whipping cap 120 is present. The whipping cap 120 can be sized to fit the shape of the housing. The whipping cap 120 can be any type of covering shape to enclose the food ingredients inside and mate with the housing 125. The whipping cap 120 may be made of any suitable food safe material to hold and enclose the added food ingredients during connection with the housing 125 in each the whipping mode 150, dispensing mode, or in some optional storage modes of operation. For example, the whipping cap 120 may be made of a food safe plastic or other polymer-based combinations. In other examples metal or metallic alloys may be used to create the whipping cap 125. The whipping cap 125 may be solid in color or translucent depending on the materials used, and it should be understood that additional and other functionally appropriate materials may also be used to create the whipping cap 125.

As the example housing viewed in FIG. 1 is cylindrical, the whipping cap 120 is a circular shape. In should be understand that other shapes such as oval or square can be used so long as the whipping cap 120 can mate with the desired shape of the housing 125. The whipping cap 120 can attach to the housing 125 by way of threads. Rotating the whipping cap 120 can mate the threads of the housing 125 located at the upper end of the housing 125 with the threads of the whipping cap 120. In other embodiments, additional ways to fasten the whipping cap 120 and the housing 125 can be used such as fastener clips, clamps, or bolts. The whipping cap 120 may have a plurality of whipping cap protrusions 140 extending outward from the side walls of the whipping cap 120. These whipping cap protrusions 140 each help the user grasp the whipping cap 120 so that it can be easily tightened or removed by the user to access the interior of the housing 125. Removing the whipping cap 120 allows the user to place the food ingredients within the whipping and dispensing appliance 100 so that the whipped food product can be created.

In additional embodiments, and not viewed in FIG. 1, the whipping cap 120 may also include and whipping cap gasket in the interior area of the whipping cap 120. The whipping cap gasket may further be in communication and contact with the interior surface of the housing 125 opposite the housing threads on the top portion of the housing 125. The whipping cap gasket helps contain the food ingredients or other food items contained within the housing 125 when the whipping and dispensing appliance 100 is in either the whipping mode 150, dispensing mode, or in some optional uses of the storage mode. In each the whipping mode 150 and the dispensing mode of the whipping and dispensing appliance 100, the whipping cap gasket helps prevent the food ingredients contained within the housing 125 from being forced via the applied user pressure into, up, and through the threaded connection between the top end of the housing 125 between the whipping cap 120 thereby causing leakage.

In the whipping mode 150, a plunger 115 may be present. The plunger 115 can extend through the middle portion of the whipping cap 120 and into the housing 125 of the whipping and dispensing appliance 100. The plunger 115 may be a single circular rod, but other embodiments may use multiple plungers for the whipping mode 150. The bottom part of the plunger 115 attaches to the mixing elements (not shown) while the top end of the plunger 115 can attach to a plunger handle 105. The plunger handle 105 can be ergonomically designed so that it can be easily grasped by the user. The plunger 115 is depressed downward towards the interior of the housing 125 and then back upwards away from the housing 125 in a continuous motion to create the whipped food product when the whipping and dispensing appliance 100 is used in the whipping mode 150 of operation. The plunger handle 105, in some embodiments, may be a multiple component piece. The plunger handle 105 may have a top plunger plate 110 that is attached to the plunger handle 105. The top plunger plate 110 may be textured to help the user grip the plunger handle 105 or may show other identifying features of the whipping and dispensing appliance 100 including but not limited to manufacturer information and operational information.

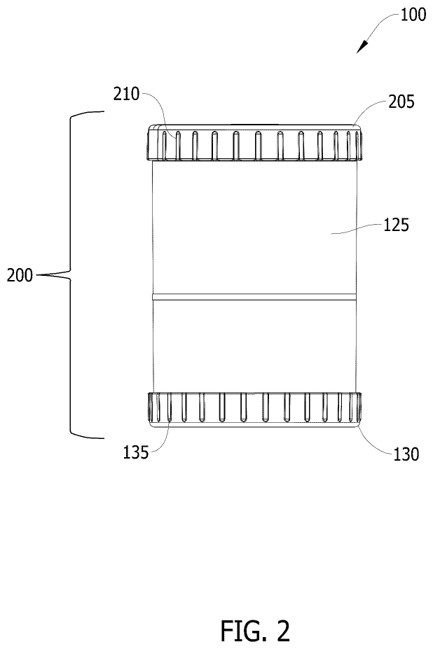

Turning now to FIG. 2, the whipping and dispensing appliance 100 is viewed in a storage mode 200 of operation. In the storage mode 200, the whipped food product has already been created by the whipping mode 150 and is housed within the housing 125. The storage mode 200 can allow the whipped food product to be contained for a short amount of time or can be stored for longer periods in a refrigerated setting. The storage mode 200 limits the amount of air or outside contaminants that may contact the whipped food product to create an airtight seal between the connections of the housing 125 and the associated caps. In the storage mode 200, a housing 125 is still present. While the housing 125 can be an additional secondary container, it is envisioned that the housing 125 is the same container used by the whipping and dispensing appliance 100 in the whipping mode 150 of operation. At the bottom end of the housing 125, the storage cap 130 may be present. The storage cap 130 may be the same storage cap 130 used in the whipping mode 150 to limit the amount of air or outside contaminants contacting the whipped food product. Entry of air or other outside contaminants into the housing 125 is further accomplished by the gasket located in the interior area of the storage cap 130. The gasket may contact, communicate with, and press against the interior surface of the housing 125 opposite the lower threads of the housing 125 to which the storage cap 130 attaches. Effectively, a three-contact point seal is created between the storage cap 130 and the housing 125 in the storage mode 200 and the whipping mode 150 of operation. In this configuration, the gasket would contact the interior surface of the housing 125 while the threads of the housing contact and connect with the corresponding threads on the storage cap 130. A final contact point between the interior surface of the storage cap 130 located between the storage cap threads and the gasket may also contact, communicate with, and press against a bottom edge of the housing 125 resting on the storage cap 130. Utilizing the same storage cap 130 as the whipping mode 150 also minimizes whipped food product loss as the whipped food product may stick to the storage cap 130 during the whipping mode 150 and removal of the storage cap 130 would remove valuable created whipped food product.

On the top end of the whipping and dispensing appliance 100 in the storage mode 200, the whipping cap 120 may be replaced with a second storage cap 205. Alternatively, the whipping cap 120 can also be used in a storage mode 200 of operation. However, use of a second storage cap 205 is preferred as additional sealing features may be present on the second storage cap 205 and not on the whipping cap 120 to further add in the longevity and storage life of the created whipped food product within the housing 125.

The second storage cap 205 and be similar in design and form to the storage cap 130 located on the bottom end of the housing 125. The second storage cap 205 can be sized to fit the shape of the housing 125 and to mirror the desired shape of the housing 125. The second storage cap 205 can be any type of covering shape to enclose the food ingredients inside and mate with the housing 125. The second storage cap 205 may be made of any suitable food safe material to hold and enclose the added food ingredients during connection with the housing 125 in the storage mode 200 of operation. For example, the second storage cap 205 may be made of a food safe plastic or other polymer-based combinations. In other examples metal or metallic alloys may be used to create the second storage cap 205. The second storage cap 205 may be solid in color or translucent depending on the materials used, and it should be understood that additional and other functionally appropriate materials may also be used to create the second storage cap 205.

As the example housing 125 viewed in FIG. 2 is cylindrical, the second storage cap 205 is a circular shape. In should be understand that other shapes such as oval or square can be used so long as the second storage cap 205 can mate with the desired shape of the housing 125. The second storage cap 205 can attach to the housing 125 by way of threads. Rotating the second storage cap 205 can mate the threads of the housing 125 with the threads of the second storage cap 205 at the top end of the housing 125 in the same manner to which the whipping cap 120 is attached to the top end of the housing 125. In such a manner, the second storage cap 205 fits onto the exterior surface of the housing 125 at the housing thread location. In additional embodiments, and not viewed in FIG. 2, the second storage cap 205 may also include a second cap gasket in the interior area of the second storage cap 205. The second cap gasket may further be in communication and contact with the interior surface of the housing 125 opposite the housing threads at the top end of the housing 125. The second cap gasket helps contain the food ingredients or other food items contained within the housing 125 when the whipping and dispensing appliance 100 is in the storage mode 200 of operation.

Further, entry of air or other outside contaminants into the housing 125 is aided by the second cap gasket located in the interior area of the second storage cap 205. The second cap gasket may contact, communicate with, and press against the interior surface of the housing 125 opposite the upper threads of the housing 125 to which the second storage cap 205 attaches. Effectively, a three-contact point seal is created between the second storage cap 205 and the housing 125 in the storage mode 200 of operation. In this configuration, the second cap gasket would contact the interior surface of the housing 125 while the threads of the housing at the top end of the housing 125 contact and connect with the corresponding threads on the second storage cap 205. A final contact point between the interior surface of the second storage cap 205 located between the second storage cap threads and the second cap gasket may also contact, communicate with, and press against a top edge of the housing 125 resting on the second storage cap 205.

In other embodiments, additional ways to fasten the second storage cap 205 and the housing 125 can be used such as fastener clips, clamps, or bolts. The second storage cap 205 may have a plurality of second storage cap protrusions 210 extending outward from the side walls of the second storage cap 205. These second storage cap protrusions 210 each help the user grasp the second storage cap 205 so that it can be easily tightened or removed by the user to access the interior of the housing 125. Accessing the interior of the housing 125 can allow the user to remove the stored whipped food product from the housing 125, disassemble the housing 125 from the second storage cap 205 for easy cleaning and washing, and can also allow the user to change the mode of operation of the whipping and dispensing appliance 100 when storage mode 200 is no longer desired.

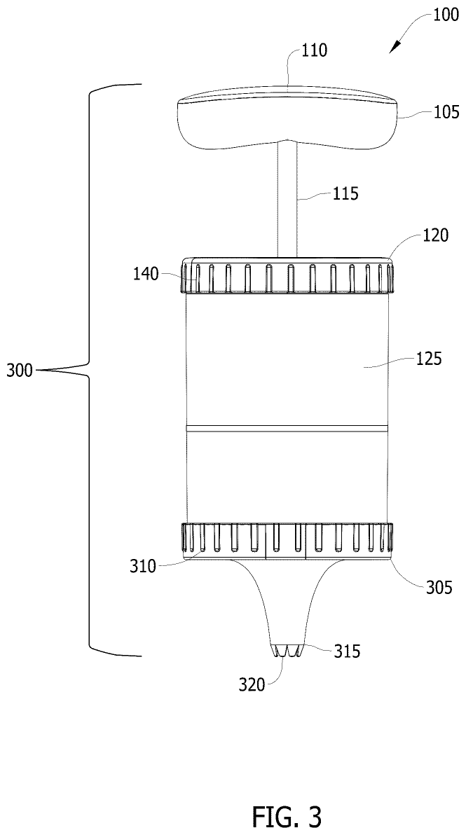

FIG. 3 shows the whipping and dispensing appliance 100 in a dispensing mode 300 of operation. In the dispensing mode 300, the whipped food product is contained within the housing 125. The whipping and dispensing appliance 100 can change quickly from the whipping mode 150 to the dispensing mode 300 so that the freshly whipped food product, such as whipped cream, can quickly be dispensed onto the user's desired food item or baked goods. The dispensing mode 300 also allows the user the ability to creatively decorate the food item or baked goods with the whipped food product.

In the dispensing mode 300 of the whipping and dispensing appliance 100, the housing 125 may be present. It is envisioned that the housing 125 is the same housing 125 used during the whipping mode 150 of operation so that transfer of the whipped food product can quickly occur. Of course, the housing 125 may be a second or additional whipping and dispensing appliance 100 into which the whipped food product can be added for dispensing. On the top end of the housing 125, the whipping cap 120 may be present with the plurality of whipping cap protrusions 140. The whipping cap 120 can attach to the housing in the same fashion described above and the whipping cap protrusions 140 allow for an easy grasping point for the user when manipulating the whipping and dispensing appliance 100 to dispense the whipped food product in the dispensing mode. A plunger 115 may also be present and extending through the middle portion of the whipping cap 120 and into the interior of the housing 125. At one end of the plunger 115, the dispensing element (not shown) may be attached to push out the whipped food product. At the other end of the plunger 115, a plunger handle 105 may be present. The plunger handle 105 allows the user to easily grasp the plunger 115 and manipulate it to control the release of the whipped food product contained within the housing 125. The plunger handle 105 may have a top plunger plate 110 that snap fits onto the plunger handle 105. The top plunger plate 110 can be textured to help the user grip the plunger handle 105 and depress the plunger 115 to disperse the whipped food product from the interior of the housing 125.

At the bottom end of the housing 125, a dispensing cap 305 may be present in the dispensing mode 300 of operation. The dispensing cap 305 can be sized to fit the shape of the housing 125 and to mirror the desired shape of the housing 125. The dispensing cap 305 can be any type of covering shape to enclose the food ingredients inside and mate with the housing 125 and to allow the created whipped food product to easily flow against the interior surface of the dispensing cap 305 and finally through the dispensing cap 305. The dispensing cap 305 may be made of any suitable food safe material to hold, direct, and contain the whipped food product during connection with the housing 125 in the dispensing mode 300 of operation. For example, the dispensing cap 305 may be made of a food safe plastic or other polymer-based combinations. In other examples metal or metallic alloys may be used to create the dispensing cap 305. The dispensing cap 305 may be solid in color or translucent depending on the materials used, and it should be understood that additional and other functionally appropriate materials may also be used to create the dispensing cap 305.

As the example housing 125 viewed in FIG. 3 is cylindrical, the dispensing cap 305 is a circular shape. In should be understand that other shapes such as oval or square can be used so long as the dispensing cap 305 can mate with the desired shape of the housing 125 and allow directed flow of the whipped food product. The dispensing cap 305 can attach to the housing 125 by way of threads. Rotating the dispensing cap 305 can mate the threads of the housing 125 with the threads of the dispensing cap 305. In such a manner, the dispensing cap 305 fits onto the exterior surface of the housing 125 at the housing thread location located at the bottom of the housing 125. In additional embodiments, and not viewed in FIG. 3, the dispensing cap 305 may also include and dispensing gasket in the interior area of the dispensing cap 305. The dispensing gasket may be operationally similar to the gasket, whipping cap gasket, and second cap gasket described above and may further be in communication and contact with the interior surface of the housing 125 opposite the housing threads at the bottom end of the housing 125. The dispensing gasket helps contain the created whipped food products contained within the housing 125 and directed towards the desired opening of the dispensing cap 305 when the whipping and dispensing appliance 100 is in the dispensing mode 300 of operation. In the dispensing mode 300 of the whipping and dispensing appliance 100, the dispensing gasket helps prevent the created whipped food product contained within the housing 125 from being forced via the applied user pressure into and through the threaded connection of on the exterior bottom end of the housing 125 between the dispensing cap 305 and the housing 125.

As the example housing 125 viewed in FIG. 3 is cylindrical, the dispensing cap 305 is a circular shape. In other embodiments, additional ways to fasten the dispensing cap 305 and the housing 125 can be used such as fastener clips, clamps, or bolts. The dispensing cap 305 may have a plurality of dispensing cap protrusions 310 extending outward from the side walls of the dispensing cap 305. These protrusions help the user grasp the dispensing cap 305 so that it can be easily tightened or removed by the user to access the interior of the housing. The protrusions can also provide an easy grasping point for the user when dispensing the whipped food product from the interior of the housing 125.

The dispensing cap 305 is different from the whipping cap 120, storage cap 130, and second storage cap 205 in that it is open at both the top and bottom ends. The top end has a circular opening matching the contour of the housing 125 and allowing the created whipped food product to move downward through the dispensing cap 305. The bottom portion of the dispensing cap 305 forms a nozzle 315 or other similar type opening. The nozzle 315 may be a funnel shape that restricts the pathway through which the created whipped food product may pass. At the end of the nozzle 315, a nozzle tip 320 is present. The nozzle tip 320 can be a multitude of different decorative designs. In FIG. 3, the nozzle tip 320 is viewed as a star shaped design to give the extruded whipped food product a pleasant and aesthetically pleasing appearance as it is dispensed onto a food item or baked goods. It should be understood that the dispensing cap 305 can have many different designs for the nozzle tip 320 and these are envisioned by the inventors to be chosen by the user of the whipping and dispensing appliance 100.

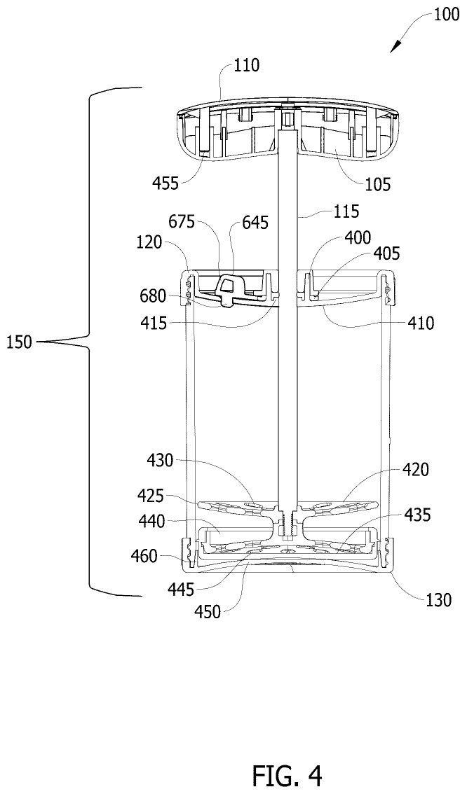

FIG. 4 shows a cross sectional view of the whipping and dispensing appliance 100 in a whipping mode 150 of operation. The housing 125 is viewed as having side walls. The side walls can be any desired thickness but should be rigid enough to maintain the shape of the housing 125 during whipping mode 150, storage mode 200, and dispensing mode 300 of operation. At the top end of the housing 125, a cross sectional view of the whipping cap 120 is shown. The whipping cap 120 may have a concave shape when looking down upon the whipping cap 120. The concave lower surface 410 of the whipping cap 120, or the interior surface of the whipping cap 120, is created to mirror the shape of the first mixing element 420. Thus, when the first mixing element 420 is raised by way of the plunger 115, the first mixing element 420 mates with the concave lower surface 410 so that there is little to no spacing between the concave lower surface 410 of the whipping cap 120 and the first mixing element 420.

Through the center of the whipping cap 120, the plunger 115 may be present. An O-ring 415, or the like may surround the plunger 115 and be housed as part of the whipping cap 120. The O-ring 415 acting as a seal contacts the plunger 115 and keeps the whipped food product within the housing 125 as the plunger 115 is raised and lowered. The O-ring 415 squeegees the side surface of the plunger 115 keeping any food ingredients or whipped food product within the housing 125 so that it does not escape through the opening where the plunger 115 is present during operational use of the whipping and dispensing appliance 100. On the top surface of the whipping cap 120, a seal 405 may be present. The seal 405 may circumnavigate the plunger 115 and be housed around a raised area of the whipping cap 120. The seal 405 can keep air within the housing 125 if needed in the whipping mode 150 of operation. In the dispensing mode 300, the seal 405 may be removed to allow air into the housing 125 interior so that the whipped food product can be dispensed. Further, keeping the seal 405 and the O-ring 415 in place, a lid cap 400 may be present. The lid cap 400 may snap fit onto the whipping cap 120 to secure placement of the O-ring 415 in contact with the plunger 115 and the seal 405 in contact with the upper surface of the whipping cap 120.

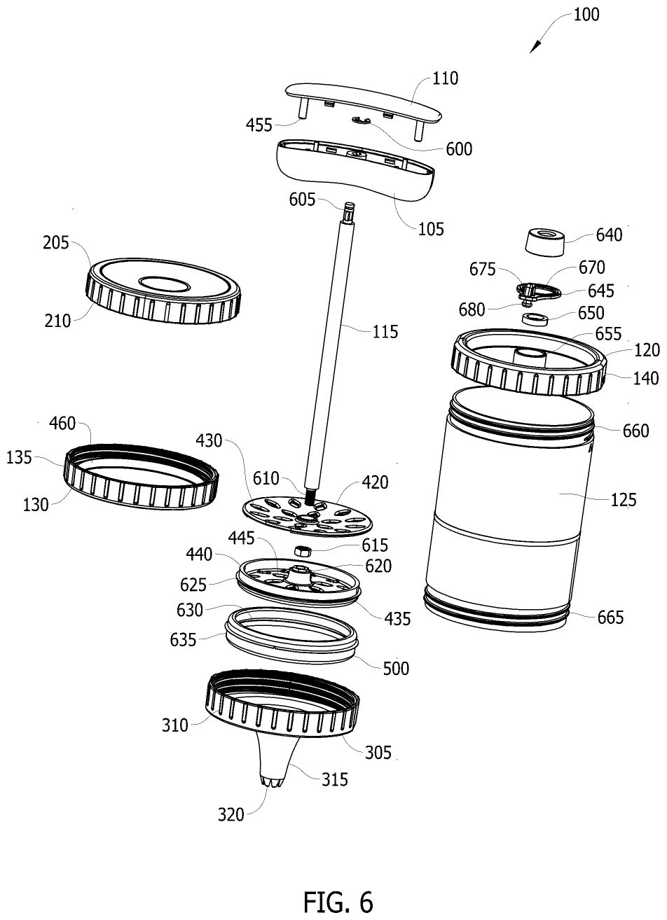

The seal 405 may not only circumnavigate the plunger 115 and be snap fitted onto the whipping cap 120 by the lid cap 400, but also extend outward and rest on the top surface of a portion of the whipping cap 120. This extension of the seal 405 is represented by element 645 viewed in totality within FIG. 6. It should be understood that the seal 405 and the seal 645 are the same element yet the cross-sectional view of FIG. 4 removes some of the visible circular connection. The seal 645 as viewed in FIG. 4 extends outward for its central loop shape that surrounds the plunger 115 entering the interior of the housing 125 of the whipping and dispensing appliance 100. The seal 645 can be made of any pliable or malleable material so that the shape and the contour of the seal 645 can be deformed for placement and movement of the seal between multiple positions. After such movement between these positions, the material of the seal 645 will then return to its original standard configuration and orientation. For example, the seal 645 as viewed in FIG. 4 may be made by a rubber or other type of plastic or malleable polymer type material, but other possible materials are envisioned for use.

The seal 645 may further have a tab 675 which can be grasped by the user to place and remove seal 645 from a resting position on the top surface of the whipping cap 120. The tab 675 may be part of the same material of the seal 645 and extend vertically upward from the resting position of the seal 645 on the top surface of the whipping cap 120. Of course, other possible configurations for easy gripping by the use can be used for the seal 645 and the tab 675. Furthermore, the seal 645 in the resting position against the top surface of the whipping cap 120 may cover and completely enclose a hole or opening within the whipping cap 120. The configuration and shape of the seal 645 may change, but it is to be at least as large but likely larger than any hole or opening of the whipping cap 120. The seal 645 can then further contain a downward extension such as a plug 680. The plug 680 is formed as part of the continuous seal 645 and may pass through the hole or opening on the whipping cap 120. Moreover, the plug 680 may have a larger end portion in both diameter and surface area than both a central portion of the plug 680 that connects to the seal 645 and larger than the hole of opening present on the whipping cap 120. The central portion of the plug 680 may be the same or slightly smaller than the hole or opening of the whipping cap 120.

The seal 645 with the tab 675 as an upward extension to be grasped by the user and the plug 680 as a downward extension to fit through a hole or opening of the whipping cap 120 may have two distinct positions. In a first position, the seal 645 may have the plug 680 located through and secured by the whipping cap 120. The first position is an airtight position where the seal 645 resting on the top surface of the whipping cap 120 prevents air from entering the interior of the housing 125 containing the food ingredients to be made into a whipped food product. Additionally, the larger end portion of the plug 680 of the seal 645 allows for a snap fit connection of the seal 645 through the hole or opening of the whipping cap 120. The larger end portion of the plug having a larger surface area or diameter of the opening or hole of the whipping cap also rests against both the hole or opening through the whipping cap 120 and the interior facing surface of the whipping cap 120. This allow for an additional airtight connection between the plug 680 of the seal 645 and the interior surface and hole or opening of the whipping cap 120 to prevent air from escaping or entering the interior of the housing 125 containing the food ingredients to be made into a whipped food product during operational use.

The first position of the seal 645, wherein the seal 645 rests on the top surface of the whipping cap 120 and the plug 680 is located in and through the hole or opening of the whipping cap 120 and contacting the interior surface of the whipping cap 120, may be used for airtight operation of the whipping and dispensing appliance 100. This first position of the seal 645 is to be used during the whipping mode 150 and the storage mode 200 of operation if the whipping cap 120 is used. This first position keeps the necessary amount of air within the interior of the housing 125 and does not allow additional air to enter or escape during operational use in either the whipping mode 150 or the storage mode 200.

The second position of the seal 645 occurs when the user grasps the seal 645, usually by the tab 675, and pulls the plug 680 upwards into and through the hole or opening of the whipping cap 120. In this second position, the seal 645 may simply rest on the top surface of the whipping cap 120 by way of the downward extension of the plug 680. The seal 645 may be further manipulated away from the hole or opening through the whipping cap 120 to a new location further from the hole or opening. In this second position, the seal 645 does not provide an airtight enclosure with the whipping cap 120. Thus, air and other outside particles may enter or flow through the hole or opening of the whipping cap 120 and into the interior of the housing 125 of the whipping and dispensing appliance 100. The seal 645 may be placed in the second position when the whipping and dispensing appliance 100 is in the dispensing mode 300 of operation. By allowing air to flow into the interior of the housing 125, the plunger 115 of the whipping and dispensing appliance 100 can more easily dispense the created whipped food product through the dispensing cap 305 located at the bottom end of the housing 125.

At the top end of the plunger 115, the plunger handle 105 may be present. The top plunger plate 110 may fit into and be attached to the plunger handle 105. Snap fittings 455 secure the top plunger plate 110 into the plunger handle 105. The plunger 115 itself may also be secured to the plunger handle 105. The top end of the plunger 115 may be threaded so that it can screw into each the plunger handle 105 and the top plunger plate 110.

At the bottom end of the housing 125, the storage cap 130 is present. The storage cap 130 may have a convex shape when looking down upon the storage cap 130. The convex upper surface 450 of the storage cap 130 is created to mirror the shape of the second mixing element 435. Thus, when the second mixing element 435 is lowered by way of the plunger 115, the second mixing element 435 mates with the convex upper surface 450 so that there is little to no spacing between the convex upper surface 450 of the storage cap 130 and the second mixing element 435.

The storage cap 130 may be used during both whipping mode 150 and storage mode 200 of the whipping and dispensing appliance 100. The storage cap 130 can be sized to fit the shape of the housing 125. As seen in FIG. 4, the storage cap 130 is a circular shape. The storage cap 130 can attach to the housing 125 by way of threads. Rotating the storage cap 130 can mate the threads of the bottom end of the housing 125 with the threads of the storage cap 130. In other embodiments, additional ways to fasten the storage cap 130 and the housing 125 can be used such as fastener clips, clamps, or bolts. The storage cap 130 may have a plurality of storage cap protrusions 135 extending outward from the side walls of the storage cap 130. These storage cap protrusions 135 help the user grasp the storage cap 130 so that it can be easily tightened or removed by the user to access the interior of the housing 125 and the whipped food product.

Also viewed in FIG. 4 is a gasket 460 located on and raising up from the interior surface of the storage cap 130. The gasket 460, as viewed in Figure may extend upwards to a height of approximately half or more than one half of the height of the side walls of the storage cap 130. The gasket 460 is circular and circumscribes the entire interior surface location where it is located on the storage cap 130. The gasket 460 may further be in communication and contact with the interior surface of the housing 125 opposite the housing threads. The gasket 460 helps contain the food ingredients or other food items contained within the housing 125 when the whipping and dispensing appliance 100 is in either the whipping mode 150, dispensing mode 300, or storage mode 200. In each the whipping mode 150 and the dispensing mode 300 of the whipping and dispensing appliance 100, the gasket 460 helps prevent the food ingredients contained within the housing 125 from being forced via the applied user pressure on the plunger 115 into, up, and through the threaded connection between the housing 125 and the storage cap 130 thereby causing leakage.

Moreover, the storage cap 130 may limit the amount of air or outside contaminants contacting the whipped food product. Entry of air or other outside contaminants into the housing 125 is further accomplished by the gasket 460 located in the interior area of the storage cap 130. The gasket 460 may contact, communicate with, and press against the interior surface of the housing 125 opposite the lower threads of the housing 125 to which the storage cap 130 attaches. Effectively, a three-contact point seal is created between the storage cap 130 and the housing 125 in the storage mode 200 and the whipping mode 150 of operation. In this configuration, the gasket 460 would contact the interior surface of the housing 125 while the threads of the housing contact and connect with the corresponding threads on the storage cap 130. A final contact point between the interior surface of the storage cap 130 located between the storage cap threads and the gasket 460 may also contact, communicate with, and press against a bottom edge of the housing 125 resting on the storage cap 130. This configuration and seal with the gasket 460 minimizes whipped food product loss to prevent further leakage of the whipping and dispensing appliance 100.

At the bottom end of the plunger 115, a plurality of mixing elements may be present. While two different mixing elements are viewed in FIG. 4, it should be understood that a different number of mixing elements or mixing element designs may be used to create the whipping and dispensing appliance 100. A first mixing element 420 is located on the top portion of the bottom end of the plunger 115. The first mixing element 420 may be circular in nature to fit the dimensions of the housing 125 or as appropriate based on the housing 125 shape. The first mixing element 420 viewed in FIG. 4 is a concave disc shape that can mate with the concave lower surface 410 of the whipping cap 120 when the plunger 115 is raised. The first mixing element 420 may have a first mixing element opening 430. There may be a plurality of first mixing elements openings 430 spaced throughout the disc shape of the first mixing element 420. The first mixing element 420 may have a lower surface protrusion that can then mate with the upper surface protrusion of the second mixing element and surround the plunger 115. The first mixing element 420 can be affixed and secured to the plunger by threads so that it can screw onto and be secured to the plunger 115.

Below the first mixing element 420, the second mixing element 435 is present. The second mixing element 435 may be circular in nature to fit the dimensions of the housing 125 or as appropriate based on the housing 125 shape. The second mixing element 435 viewed in FIG. 4 is a convex disc shape that can mate with the convex upper surface 450 of the storage cap 130 when the plunger 115 is lowered. The second mixing element 435 may have a second mixing element opening 445. There may be a plurality of second mixing elements openings 445 spaced throughout the disc shape of the second mixing element 435. The second mixing element may have an upper surface protrusion that can then mate with the lower surface protrusion of the first mixing element and surround the plunger 115. The second mixing element 435 can be affixed and secured to the plunger 115 by threads so that it can screw onto and be secured to the plunger 115.

The bottom surface of the second mixing element 435 is convex to meet the convex upper surface 450 of the storage cap 130. The plurality of second mixing element openings 445 may be positioned in different locations through the second mixing element 435 compared to the spacing of the plurality of first mixing element openings 430 on the first mixing element 420. The first mixing element 420 may have a first mixing element side edge 425. The first mixing element side edge 425 may be close to the side walls of the interior of the housing 125. The first mixing element 420 may have a larger diameter than the second mixing element 435. The second mixing element 435 may have an extended side wall 440 that is part of the second mixing element 435. The second mixing element 435 with the extended side wall 440 is used in the dispensing mode 300 of operation but also provides additional contact area in the whipping mode 150 so that the whipped food product can be created quicker and more efficiently.

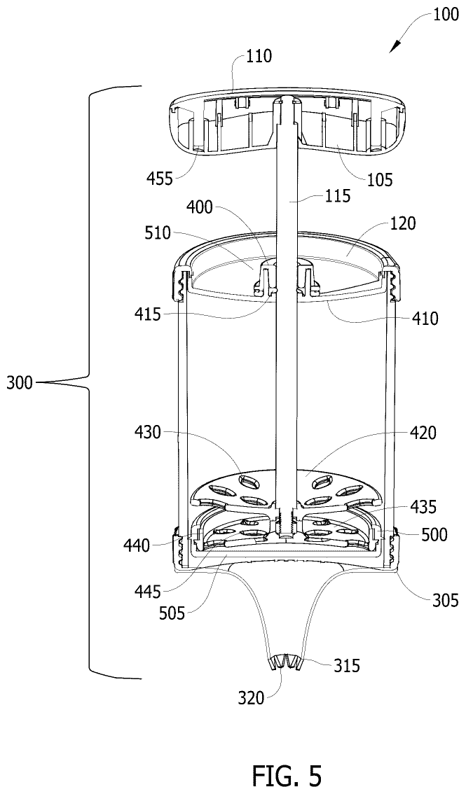

FIG. 5 shows a cross sectional view of the whipping and dispensing appliance 100 in a dispensing mode 300 of operation. The housing 125, is viewed as having side walls. The side walls can be any desired thickness but should be rigid enough to maintain the shape of the housing 125 during whipping mode 150, storage mode 200, and dispensing mode 300. At the top end of the housing 125, a cross sectional view of the whipping cap 120 is shown. The whipping cap 120 may have a concave shape when looking down upon the whipping cap 120. The concave lower surface 410 of the whipping cap 120 is created to mirror the shape of the first mixing element 420. Thus, when the first mixing element 420 is raised by way of the plunger 115, the first mixing element 420 mates with the concave lower surface 410 so that there is little to no spacing between the concave lower surface 410 of the whipping cap 120 and the first mixing element 420.

Through the center of the whipping cap 102, the plunger 115 may be present. An O-ring 415, or the like, may surround the plunger 115 and be housed as part of the whipping cap 120. The O-ring 415 contacts the plunger 115 and keeps the whipped food product within the housing 125 as the plunger 115 is raised and lowered. The O-ring 415 squeegees the side surface of the plunger 115 keeping any food ingredients or whipped food product within the housing 125 so that it does not escape through the opening where the plunger 115 is present during operational use of the whipping and dispensing appliance 100. On the top surface of the whipping cap 120, a seal 510 may be present. The seal 510 is the same in nature as the seal 410 of FIG. 4 and seal 645 of FIG. 6 as discussed above. The seal 510 may circumnavigate the plunger 115 and be housed around a raised area of the whipping cap 120. The seal 510 can keep air within the housing 125 if needed in the whipping mode 150 of operation. In the dispensing mode 300, the seal 510 may be removed, by the use through way of the tab 675 and plug 680 discussed above but not viewed in FIG. 5, to allow air into the housing 125 interior so that the whipped food product can be dispensed. Further, keeping the seal 510 and the O-ring 415 in place, a lid cap 400 may be present. The lid cap 400 may snap fit onto the whipping cap 120 to secure placement of the O-ring 415 in contact with the plunger 115 and the seal 510 in contact with the upper surface of the whipping cap 120.

At the top end of the plunger 115, the plunger handle 105 may be present. The top plunger plate 110 may fit into and be attached to the plunger handle 105. Snap fittings 455 secure the top plunger plate 110 into the plunger handle 105. The plunger 115 itself may also be secured to the plunger handle 105. The top end of the plunger 115 may be threaded so that it can screw into each the plunger handle 105 and the top plunger plate 110.

At the bottom end of the housing 125, a dispensing cap 305 may be present in the dispensing mode 300 of operation. As the example housing viewed in FIG. 5 is cylindrical, the dispensing cap 305 is a circular shape. The dispensing cap 305 can attach to the housing 125 by way of threads. Rotating the dispensing cap 305 can mate the threads of the housing 125 with the threads of the dispensing cap 305. The dispensing cap 305 may have a plurality of dispensing cap protrusions 310 extending outward from the side walls of the dispensing cap 305. These dispensing cap protrusions 310 help the user grasp the dispensing cap 305 so that it can be easily tightened or removed by the user to access the interior of the housing 125. The dispensing cap protrusions 310 can also provide an easy grasping point for the user when dispensing the whipped food product from the interior of the housing 125.

The top end of the dispensing cap 305 has a circular opening matching the contour of the housing 125 and allowing the whipped food product to move downward through the dispensing cap 305. The bottom portion of the dispensing cap 305 forms a nozzle 315. The nozzle 315 may be a funnel shape that restricts the pathway through which the whipped food product can pass. At the end of the nozzle 315, a nozzle tip 320 is present. The nozzle tip 320 can be a multitude of different decorative designs. In FIG. 5, the nozzle tip is viewed as a star shaped design to give the extruded whipped food product a pleasant and aesthetically pleasing appearance as it is dispensed onto a food item or baked goods. It should be understood that the dispensing cap 305 can have many different designs for the nozzle tip 320 and these are envisioned by the inventors to be chosen by the user of the whipping and dispensing appliance 100.

At the bottom end of the plunger 115, a plurality of mixing elements may be present. While two different mixing elements are viewed in FIG. 5, it should be understood that a different number of mixing elements, or mixing element designs, may be used to create the whipping and dispensing appliance 100. A first mixing element 420 is located on the top portion of the bottom end of the plunger 115. The first mixing element 420 may be circular in nature to fit the dimensions of the housing 125. The first mixing element 420 viewed in FIG. 5 is a concave disc shape that can mate with the concave lower surface 410 of the whipping cap 120 when the plunger 115 is raised. The first mixing element 420 may have a first mixing element opening 430. There may be a plurality of first mixing elements openings 430 spaced throughout the disc shape of the first mixing element 420. The first mixing element 420 may have a lower surface protrusion that can then mate with the upper surface protrusion of the second mixing element 435 and surround the plunger 115. The first mixing element 420 can be affixed and secured to the plunger 115 by threads so that it can screw onto and be secured to the plunger 115.

Below the first mixing element 420, the second mixing element 435 is present. The second mixing element 435 may be circular in nature to fit the dimensions of the housing 125. The second mixing element 435 viewed in FIG. 5 is a convex disc shape. The second mixing element 435 may have a second mixing element opening 445. There may be a plurality of second mixing elements openings 445 spaced throughout the disc shape of the second mixing element 435. The second mixing element may have an upper surface protrusion that can then mate with the lower surface protrusion of the first mixing element and surround the plunger 115. The second mixing element 435 can be affixed and secured to the plunger 115 by threads so that it can screw onto and be secured to the plunger 115.

The plurality of second mixing element openings 445 may be positioned in different locations through the second mixing element 435 compared to the spacing of the plurality of first mixing element openings 430 on the first mixing element 420. The first mixing element 420 may have a first mixing element side edge 425. The first mixing element side edge may be close to the side walls of the interior of the housing. The first mixing element 420 may have a larger diameter than the second mixing element 435. The second mixing element 435 may have an extended side wall 440 that is part of the second mixing element 435. The second mixing element 435 with the extended side wall 440 is used in the dispensing mode 300 of operation but also provides additional contact area in the whipping mode 150 so that the whipped food product can be created quicker and more efficiently.

In the dispensing mode 300 of operation, a plunger disc 505 is present. The plunger disc 505 through the use of the plunger 115 allows the user to dispense the whipped food product out of the whipping and dispensing appliance 100. The plunger disc 505 may be a circular shape as viewed in FIG. 5 or can be any desired shape based on the shape of the housing 125. The lower surface of the plunger disc 505 may be level and a flat surface so that downward force on the plunger 115 with the attached plunger disc 505 pushes the created whipped food product downward and out of the nozzle 315 of the dispensing cap 305. The plunger disc 505 can fit onto and be removably attached to the second mixing element 435. When the whipped food product is ready for dispensing, the user can remove the whipping cap 120 and along with it the plunger 115 and its connected elements. The user can then attach the plunger disc 505 to the second mixing element 435 so that the bottom surface of the second mixing element 435 is covered by the plunger disc 505. The plunger disc has a raised plunger side wall 500 that can cover and attach to the extended side wall 440 of the second mixing element 435. An upper lip of the plunger side wall 500 can contact part of the upper surface of the edge of the extended side wall 440 of the second mixing element 435 to keep the plunger disc 505 in place. The plunger disc 505 may also have a groove into which an edge extension of the side mixing element 435 can fit and be secured. The user can then place the whipping cap 120 back onto the housing 125 and the plunger disc 505 can be depressed to dispense the whipped food product out of the nozzle tip 320 of the dispensing cap 305. Unlike the shape of the storage cap 130, the plunger disc 505 is a flat planar surface that can equally move the whipped food product in a downward direction. The plunger side walls 500 may also have a wiper that can contact the side walls of the housing 125 interior so that all of the whipped food product can be pushed downward and out of the nozzle tip 320 at the discretion of the user.

Turning now to FIG. 6, the components of the whipping and dispensing appliance 100 are viewed as exploded and away from one another. As seen in FIG. 6, the storage cap 130 with protrusions 135 may be present and attached to the bottom portion of the housing 125 in the whipping mode 150 and storage mode 200 of the whipping and dispensing appliance 100. These storage cap protrusions 135 each help the user grasp the storage cap 130 so that it can be easily tightened or removed by the user to access the interior of the housing 125 for removal of food ingredients, whipped food product, or for cleaning purposes after operational use.

The storage cap 130 may also include a gasket 460 in the interior area of the storage cap 130. The gasket 460 may further be in communication and contact with the interior surface of the housing 125 opposite the housing threads. The gasket 460 helps contain the food ingredients or other food items contained within the housing 125 when the whipping and dispensing appliance 100 is in either the whipping mode 150 or storage mode 200. In some embodiments, the whipping cap 120 and dispensing cap 130 may also have similar gaskets for use each the whipping mode 150, storage mode 200, and dispensing mode 300. In each the whipping mode 150 and the storage mode 200 of the whipping and dispensing appliance 100, the gasket 460 helps prevent the food ingredients contained within the housing 125 from being forced via the applied user pressure on the plunger 115 into and through the threaded connection of on the exterior of the housing 125 between the storage cap 130 and the housing 125.

Further, entry of air or other outside contaminants into the housing 125 is aided by the gasket 460 located in the interior area of the storage cap 130. The gasket 460 may contact, communicate with, and press against the interior surface of the housing 125 opposite the lower threads of the housing 125 to which the storage cap 130 attaches. Effectively, a three-contact point seal is created between the storage cap 130 and the housing 125 in the storage mode 200 and the whipping mode 150 of operation. In this configuration, the gasket 460 would contact the interior surface of the housing 125 while the threads of the housing at the lower end of the housing 125 contact and connect with the corresponding threads on the storage cap 130. A final contact point between the interior surface of the storage cap 130 located between the storage cap threads and the gasket 460 may also contact, communicate with, and press against a bottom edge of the housing 125 resting on the storage cap 130.

The second storage cap 205 is also viewed with second storage cap protrusions 210. The second storage cap 205 can be affixed and secured to the top portion of the housing 125 in a storage mode 200 of operation of the whipping and dispensing appliance 100. The second storage cap 205 may also include and second cap gasket (not viewable), but similar gasket 460 viewed in FIG. 6, in the interior area of the second storage cap 205. The second cap gasket may further be in communication and contact with the interior surface of the housing 125 opposite the housing threads at the top end of the housing 125. The second cap gasket helps contain the food ingredients or other food items contained within the housing 125 when the whipping and dispensing appliance 100 is in the storage mode 200 of operation.

Further, entry of air or other outside contaminants into the housing 125 is aided by the second cap gasket located in the interior area of the second storage cap 205. The second cap gasket may contact, communicate with, and press against the interior surface of the housing 125 opposite the upper threads of the housing 125 to which the second storage cap 205 attaches. Effectively, a three-contact point seal is created between the second storage cap 205 and the housing 125 in the storage mode 200 of operation. In this configuration, the second cap gasket would contact the interior surface of the housing 125 while the threads of the housing at the top end of the housing 125 contact and connect with the corresponding threads on the second storage cap 205. A final contact point between the interior surface of the second storage cap 205 located between the second storage cap threads and the second cap gasket may also contact, communicate with, and press against a top edge of the housing 125 resting on the second storage cap 205.

At the top middle of FIG. 6, the plunger handle 105 is viewed. The plunger handle 105 may have a top plunger plate 110 attached and affixed to the plunger handle 105. Snap fittings 455 can connect and secure the plunger handle 105 to the top plunger plate 110. A rod fixer 600 may be present and located where the plunger handle 105 meets the top plunger plate 110. The top rod portion 605 of the plunger 115 can be threaded and secured to each the plunger handle 105 and the top plunger plate 110 by the rod fixer 600.

The bottom rod portion 610 may have a smaller diameter than the plunger 115. The bottom rod portion 610 can be threaded to affix and secure the first mixing element 420 and the second mixing element 435 to the plunger 115. The bottom rod portion 610 may be moved through the center portion of the first mixing element 420 and affixed to a nut 615 that can be housed within the first or second mixing elements (420 or 435). The first mixing element may have a plurality of first mixing element openings 430 located throughout and through the surface of the first mixing element 420.

The bottom rod portion 610 can then affix and attach to the second mixing element 435. The upper extension 620 of the second mixing element 435 can be secured to the nut 615 itself and be threaded to secure the second mixing element 435 with the secured nut 615 directly to the bottom rod portion 610. The second mixing element 435 may have a plurality of second mixing element openings 445 spaced throughout and through the surface of the second mixing element 435. The extended side wall 440 of the second mixing element 435 may extend upward from the peripheral edge of the second mixing element 435. An edge extension 625 of the second mixing element 435 can extend outward from the extended side wall 440 and be able to secure the plunger disc 505 to the second mixing element 435.

The plunger disc 505 is viewed below the second mixing element 435. The plunger disc 505 may be circular and have a groove 630 located on the interior of the plunger side wall 500. The groove 630 can fit onto the edge extension 625 of the second mixing element 435 to secure the plunger disc 505 to the second mixing element in the dispensing mode 300 of operation. The plunger disc 505 may also have a wiper 635 being an outward extension on the plunger side wall 500. The wiper 635 can contact the side walls of the interior of the housing 125 so that all of the whipped food product can be pressed downward and out of the housing 125 in the dispensing mode 300 of operation.

Below the plunger disc 505, the dispensing cap 305 is viewed. As discussed above, the dispensing cap 305 may have a plurality of dispensing cap protrusions 310. The lower portion of the dispensing cap 305 creates a nozzle 315. The nozzle tip 320 is where the whipped product is dispensed from the whipping and dispensing appliance 100 through the dispensing cap 305. In some embodiments, the dispensing cap may also include a dispensing gasket (not viewed) in the interior area of the dispensing cap 305. The dispensing gasket may be operationally similar to the gasket 460, the dispensing whipping cap gasket, and second cap gasket described above and may further be in communication and contact with the interior surface of the housing 125 opposite the housing threads at the bottom end of the housing 125.

On the right side of FIG. 6, the whipping cap 120 is viewed. The whipping cap 120 is formed by a plurality of different components and fitted together during assembly of the whipping and dispensing appliance 100. The whipping cap 120 may have a plurality of whipping cap protrusion 140 circumnavigating the circumference of the whipping cap 120. A whipping cap extension 655 may be present in the center, or central region, of the whipping cap 120. The plunger 115 may fit through the center of the whipping cap extension 655. The O-ring 650 may rest within the whipping cap extension 655 and surround the plunger 115. A seal 645 may surround the whipping cap extension 655 and be securable to the whipping cap extension 655 by its circular nature surrounding the whipping cap extension 655. The seal 645 is a circular design 670 in nature and has an extension at one portion of the circular design 670. The circular design 670 allows the seal 645 to be movable around the whipping cap extension 655. The seal may have a plug 680 that can fit within a hole on the surface and through the whipping cap 120. The seal 645 may also have a tab 675 which can be grasped by the user to place and remove the plug 680 from the hole on the whipping cap 120. A lid cap 640 can then be placed over the whipping cap extension 655 to hold the seal 645, O-ring 650, and plunger 115 in place and through the whipping cap 120.

Below the whipping cap 120, the housing 125 is present. The housing 125 viewed in FIG. 6 is a cylinder, but other designs are envisioned. The housing 125 may have a top threaded portion 660 that can mate the top portion of the housing 125 with either the whipping cap 120 or the second storage cap 205. The housing 125 may also have a bottom threaded portion 665 that can mate the bottom portion of the housing 125 with either the storage cap 130 or the dispensing cap 305. During both whipping mode 150 and dispensing mode 300, the components of the mixing elements and at least part of the plunger are contained within the interior of the housing 125.

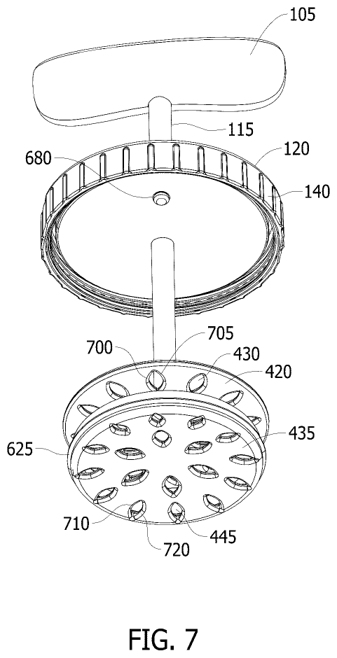

FIG. 7 shows an angled view of the mixing apparatus used by the whipping and dispensing appliance 100 during the whipping mode 150 of operation. The mixing apparatus is removed from the housing 125 where the creation of the whipped food product can occur. The whipping cap 120 is viewed with a plurality of whipping cap protrusions 140 that can circumnavigate the edge of the whipping cap 120. The plunger 115 is connected to the plunger handle 105 at a first end and the first mixing element 420 and second mixing element 435 at the second end. In the whipping mode 150, plug 680 of the seal 645 is positioned through and secured below the surface of the whipping cap 120. Plug 680 is part of the seal 645 and during whipping it is important to create as much of a vacuum space as possible to quickly create the whipped food product. Moreover, the plug 680 may have a larger end portion in both diameter and surface area than both a central portion of the plug 680 that connects to the seal 645 and larger than the hole of opening present on the whipping cap 120. The central portion of the plug 680 may be the same or slightly smaller than the hole or opening of the whipping cap 120. In the whipping mode 150, the plug 680 is depressed and secured through the hole present within the whipping cap 120 to place the seal 645 in the first position.

Additionally, the larger end portion of the plug 680 of the seal 645 allows for a snap fit connection of the seal 645 through the hole or opening of the whipping cap 120. The larger end portion of the plug 680 having a larger surface area or diameter of the opening or hole of the whipping cap 120 also rests against both the hole or opening through the whipping cap 120 and the interior facing surface of the whipping cap 120. This allow for an additional airtight connection between the plug 680 of the seal 645 and the interior surface and hole or opening of the whipping cap 120 to prevent air from escaping or entering the interior of the housing 125 containing the food ingredients to be made into a whipped food product during operational use. As seen in FIG. 7, the plug 680 and the seal 645 is located in the first position.

The first and second mixing elements 420 and 435 create the whipped food product. The plunger 115 moves the first mixing element 420 and second mixing element 435 in an upward and downward motion to agitate the mixture of ingredients to create the whipped food product. The first mixing element 420 may have a plurality of first mixing element openings 430. Through testing, the size and shape of these openings were explored by the inventors. To optimally create whipped food products such as whipped cream in a quick manner, openings that were elliptical in nature were found to have the best results. However, it should also be understood that circular, or oval, or other opening shapes may be used to created whipped food products albeit during an extended operational session of the whipping mode 150. Thus, the first mixing element openings 430 have a first side edge 700 and a second side edge 705. The first and second side edges 700 and 705 create the elliptical shape of the first mixing element openings 430. The first and second side edges 700 and 705 may be angled towards the center of the elliptical openings shape. As viewed in FIG. 7, the angle of the first side edge 700 and the second side edge 705 is upward towards the center of the elliptical opening on the bottom surface of the first mixing element 420. Correspondingly, the upper surface of the first mixing element 420 may have the angle of the first side edge 700 and the second side edge 705 downward towards the center of the elliptical opening when viewed from the top. This angled design helps aid the food ingredients through the openings at a proper amount of agitation and velocity to create the desired whipped food product.

The second mixing element 435 may have a plurality of second mixing element openings 445. Through testing, the size and shape of these openings were explored by the inventors. To optimally create whipped food products such as whipped cream in a quick manner, openings that were elliptical in nature were found to have the best results. However, it should also be understood that circular, or oval, or other opening shapes may be used to created whipped food products albeit during an extended operational session of the whipping mode 150. Thus, the second mixing element openings 445 have a third side edge 710 and a fourth side edge 720. The third and fourth side edges 710 and 720 create the elliptical shape of the second mixing element openings 445. The third and fourth side edges 710 and 720 may be angled towards the center of the elliptical openings shape. As viewed in FIG. 7, the angle of the third side edge 710 and the fourth side edge 720 is upward towards the center of the elliptical opening on the bottom surface of the second mixing element 435. Correspondingly, the upper surface of the second mixing element 435 may have the angle of the third side edge 710 and the fourth side edge 720 downward towards the center of the elliptical opening when viewed from the top. This angled design helps aid the food ingredients through the openings at a proper amount of agitation and velocity to create the desired whipped food product.

The first mixing element openings 430 and the second mixing element openings 445 are located on different locations of the first mixing element 420 and the second mixing element 435. The first mixing element openings 430 and the second mixing element openings 445 are envisioned to not be in alignment with one another in their respective locations on the first mixing element 420 and the second mixing element 435. While direct alignment is possible, this offset design allows for increased agitation and velocity so that the created whipped food product can be made in the least amount of operational time. Thus, food ingredients traveling from below the second mixing element 435 to above the first mixing element 420 pass through these off-set openings further aiding in the agitation needed to create the whipped food product. The number of openings on each the first mixing element 420 and the second mixing element 435 may also differ and may be preferable for optimal operation in the whipping mode 150 of the whipping and dispensing appliance 100. In testing, the inventors found that whipped food products may be created quickest by utilizing a greater amount of food ingredient facing/contacting surface area on the second mixing element 435 than the first mixing element 420. Thus, the first mixing element 420 would have a lesser amount of food ingredient facing/contacting surface area than the second mixing element 435. Testing showed that approximately twelve percent coverage of the second mixing element openings 445 on a theoretically planar and continuous disc representative of the second mixing element 435 was ideal for the surface area amount of openings required or envisioned on the second mixing element 435 for optimal agitation and velocity during the whipping mode 150 of operation. Further testing by the inventors found that fifteen percent coverage of the first mixing element openings 430 on a theoretically planar and continuous disc representative of the first mixing element 420 was ideal for the surface area amount of openings required or envisioned on the first mixing element 420 for optimal agitation and velocity during the whipping mode 150 of operation. Of course, different percentages of openings can be used to create the whipped food products. However, increasing or decreasing the ratio of openings to contacting surface area of the mixing elements may lead to greater resistance when depressing and lifting the plunger and an increase in creation time to actually create the desired whipped food product.

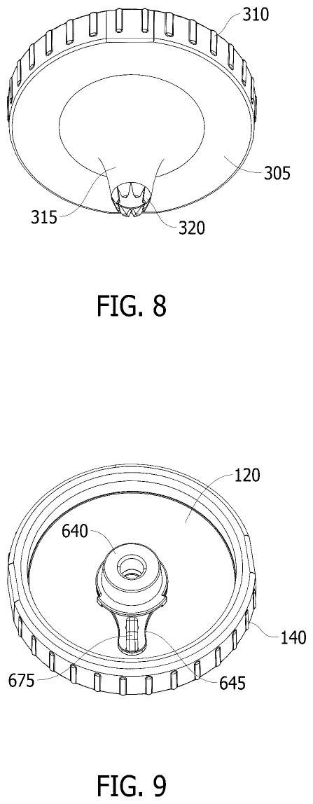

FIG. 8 illustrates a view of the dispensing cap 305 detached from the whipping and dispensing appliance 100. The dispensing cap 305 is a circular shape for use with a cylindrical housing shape. The dispensing cap 305 can attach to the housing 125 by way of threads. Rotating the dispensing cap 305 can mate the threads of the housing 125 with the threads of the dispensing cap 305. In other embodiments, additional ways to fasten the dispensing cap 305 and the housing can be used such as fastener clips, clamps, or bolts. The dispensing cap 305 may have a plurality of dispensing cap protrusions 310 extending outward from the side walls of the dispensing cap 305. These dispensing cap protrusions 310 help the user grasp the dispensing cap 305 so that it can be easily tightened or removed by the user to access the interior of the housing. The dispensing cap protrusions 310 can also provide an easy grasping point for the user when dispensing the whipped food product from the interior of the housing 125. In some embodiments, the dispensing cap 305 may also include a dispensing gasket (not viewed) in the interior area of the dispensing cap 305 located beneath the view shown in FIG. 8. The dispensing gasket may be operationally similar to the gasket 460 described above in FIGS. 1, 4, and 6, and the optional dispensing cap gasket may further be in communication and contact with the interior surface of the housing 125 opposite the housing threads at the bottom end of the housing 125 when used in the dispensing mode 300 of operation.

The dispensing cap 305 is different from the whipping cap 120, storage cap 130, and second storage cap 205 in that it is open at both the top and bottom ends. The top end has a circular opening matching the contour of the housing 125 and allowing the whipped food product to move downward through the dispensing cap 305. The bottom portion of the dispensing cap forms a nozzle 315. The nozzle 315 may be a funnel shape that restricts the pathway through which the whipped food product can pass. At the end of the nozzle 315, a nozzle tip 320 is present. The nozzle tip 320 can be a multitude of different decorative designs. In FIG. 8, the nozzle tip is viewed as a star shaped design to give the extruded whipped food product a pleasant and aesthetically pleasing appearance as it is dispensed onto a food item or baked goods. It should be understood that the dispensing cap 305 can have many different designs for the nozzle tip 320 and these are envisioned by the inventors to be chosen by the user of the whipping and dispensing appliance 100.

FIG. 9 shows the whipping cap 120 detached from the whipping and dispensing appliance 100. The whipping cap 120 is a circular shape as dictated by the design of the housing 125 and in this embodiment a cylindrical housing 125. The whipping cap 120 can attach to the housing 125 by way of threads. Rotating the whipping cap 120 can mate the threads of the housing 125 at the top portion of the housing 125 with the threads of the whipping cap 120. In other embodiments, additional ways to fasten the whipping cap 120 and the housing 125 can be used such as fastener clips, clamps, or bolts. The whipping cap 120 may have a plurality of whipping cap protrusions 140 extending outward from the side walls of the whipping cap 120. These protrusions help the user grasp the whipping cap 120 so that it can be easily tightened or removed by the user to access the interior of the housing 125. In some embodiments, the whipping cap 120 may also include a whipping cap gasket (not viewed) in the interior area of the whipping cap 120 located beneath the view shown in FIG. 9. The whipping cap gasket may be operationally similar to the gasket 460 described above in FIGS. 1, 4, and 6, and the optional whipping cap gasket may further be in communication and contact with the interior surface of the housing 125 opposite the housing threads at the top end of the housing 125.

The lid cap 640 of the whipping cap 120 is also viewed. The lid cap secures the seal 645 to the upper exterior surface of the whipping cap 120. Prongs of the lid cap 640 may hold the seal 645 with its extension to the tab 675 into place. The top portion of the seal contains a tab 675 which can be grasped by the user to place and remove the plug 680 from the hole on the whipping cap 120. A hole or opening on and through the whipping cap 120 is located below the tab 675. During whipping mode 150 or storage mode 200, the plug 680 is inserted into the hole of the whipping cap 120 placing the seal 645 into the first position. The plug 680 helps create a vacuum during creation of the whipped food product to keep the food ingredients from spilling out of the top of the whipping cap 120. In the dispensing mode 300, the tab 675 is lifted by the user removing the plug 680 from the hole in the surface of the whipping cap 120 and placing the seal 645 into the second position. Removing the plug 680 and placing the seal 645 into the second position allows air to enter the interior of the housing 125 so that the whipped food product can be dispensed easily through the dispensing cap 305 when it is attached to the whipping and dispensing apparatus 100.

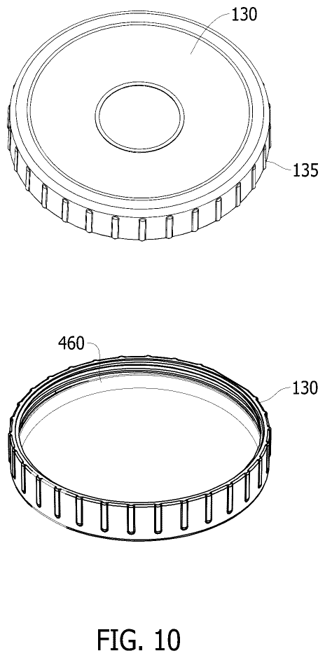

FIG. 10 shows the storage cap 130 detached from the whipping and dispensing appliance 100. The second storage cap 205 may have a similar design to the design of the storage cap 130 viewed in FIG. 10. The storage cap 130 is used during both whipping mode 150 and storage mode 200 of the whipping and dispensing appliance 100. The storage cap 130 can be sized to fit the shape of the housing 125. As seen in FIG. 10, the storage cap 130 is a circular shape. The storage cap 130 can attach to the housing 125 by way of threads. Rotating the storage cap 130 can mate the threads of the bottom end of the housing 125 with the threads of the storage cap 130 or the threads of the upper end of the housing 125 with the second storage cap 205. In other embodiments, additional ways to fasten the storage cap 130 and the housing can be used such as fastener clips, clamps, or bolts. The storage cap 130 may have a plurality of storage cap protrusions 135 extending outward from the side walls of the storage cap. These storage cap protrusions 135 help the user grasp the storage cap 130 so that it can be easily tightened or removed by the user to access the interior of the housing 125 and the whipped food product.

Also viewed in FIG. 10 is the bottom surface of the storage cap 130. The storage cap 130 may also include a gasket 460 in the interior area of the storage cap 130. The gasket 460 may further be in communication and contact with the interior surface of the housing 125 opposite the housing threads. The gasket 460 helps contain the food ingredients or other food items contained within the housing 125 when the whipping and dispensing appliance 100 is in either the whipping mode 150, dispensing mode 300, or storage mode 200. In each the whipping mode 150 and the dispensing mode 300 of the whipping and dispensing appliance 100, the gasket 460 helps prevent the food ingredients contained within the housing 125 from being forced via the applied user pressure on the plunger 115 into, up, and through the threaded connection between the housing 125 and the storage cap 130 thereby causing leakage.

Moreover, the storage cap 130 may limit the amount of air or outside contaminants contacting the whipped food product. Entry of air or other outside contaminants into the housing 125 is further accomplished by the gasket 460 located in the interior area of the storage cap 130. The gasket 460 may contact, communicate with, and press against the interior surface of the housing 125 opposite the lower threads of the housing 125 to which the storage cap 130 attaches. The same is done with the second storage cap 205 and the upper threads of the housing 125 when it may be attached in a storage mode 200 of operation. Effectively, a three-contact point seal is created between the storage cap 130 and the housing 125 in the storage mode 200 and the whipping mode 150 of operation. In this configuration, the gasket 460 would contact the interior surface of the housing 125 while the threads of the housing contact and connect with the corresponding threads on the storage cap 130. A final contact point between the interior surface of the storage cap 130 located between the storage cap threads and the gasket 460 may also contact, communicate with, and press against a bottom edge of the housing 125 resting on the storage cap 130. This configuration and seal with the gasket 460 minimizes whipped food product loss to prevent further leakage of the whipping and dispensing appliance 100.

In operational use, the whipping and dispensing appliance 100 can be started in a whipping mode 150. The whipping cap 120 with the plunger 115 and attached mixing elements is removed from the top of the housing 125. The user can then add the food ingredients into the interior of the housing 125. For whipping cream, the housing may have a line marked on the side walls (possibly transparent) indicating the amount of cream that should be added into the interior of the housing. The user can then add secondary ingredients such as powdered sugar. Then, the user replaces the whipping cap 120 back onto the housing 125 and rotates the whipping cap to secure it into place. The storage cap 130 is already secured to the base of the housing in the whipping mode 150 of operation. The user will then ensure that the plug 680 of the seal 645 is secured into and through the hole or opening on the top surface of the whipping cap 120 to make sure no ingredients can escape during the whipping action and whipping mode 150 operation. Once the connections of both the whipping cap 120 and the storage cap 130 are checked and securing, the whipping mode 150 of operation may begin by the user. To start whipping mode 150, the user will pump the plunger 115 via the plunger handle 105 the entire length of the housing 125 until the food ingredients reach the desired consistency for whatever whipped food product is to be prepared. This can be as little as thirty seconds with the proper design of the first mixing element 420 and second mixing element 435 attached to the bottom end of the plunger in the optimal configuration. Once the desired consistency for the whipped food product is achieved, the user can stop the pumping action as the whipped food product has been created. The user then has the option to switch to storage mode 200 or dispensing mode 300 for the whipping and dispensing appliance 100.

To transition to storage mode 200, the user will rotate and unscrew the whipping cap 120 and remove the plunger 115 and its attached elements including the first mixing element 420 and second mixing element 435. Once the plunger 115 and whipping cap 120 are removed, the user can secure a second storage cap 205 to the top of the housing 125. The second storage cap 205 can be rotated and affixed to the top of the housing 125 to contain the whipped food product within the interior of the housing 125 in an airtight seal. This airtight seal is further achieved by the gasket 460 on the interior surface portion of the storage cap 130 already connected to the bottom of the housing 125 from whipping mode 150, and the second cap gasket on the interior area of a second storage cap 205 to place the whipping and dispensing apparatus into a storage mode 200. The storage cap 130 with the gasket 460 and the second storage cap 205 with the second cap gasket provide multiple contact and airtight connections between the housing 125 and the respective caps at both the top portion and bottom portion of the housing 125. The whipped food product can then be stored for later use in a refrigerated storage device such as a refrigerator, cooler, or ice box.

To transition to dispensing mode 300, the user may rotate and unscrew either the whipping cap 120 or the storage cap 205 depending on the transition from the whipping mode 150 or the storage mode 200 and remove any attached components connected to either cap. The user may at this point wish to rinse the plunger 115, whipping cap 120, the first mixing element 420, and second mixing element 435 before transitioning into the dispensing mode 300. The plunger disc 505 can then be placed on a clean flat surface with the plunger side wall 500 facing upwards. The user can then place the whipping cap 120 with the plunger 115 onto the plunger disc 505. The plunger disc 505 can fit over and attach to the second mixing element 435. The edge extension 625 of the second mixing element 435 can fit into the groove 630 of the plunger disc 505. The whipping cap 120 with the plunger disc can then be reattached to the top portion of the housing 125 and rotated to secure the connection. The storage cap 130 on the bottom of the housing 125 is then rotated and removed. The dispensing cap 305 is then rotated and secured to the bottom portion of the housing 125. The user can then depress the plunger to force the whipped food product out of the nozzle 315 and nozzle tip 320 so that the whipped food product can decorate or be added to food items or baked goods. After all of the created whipped food product is dispensed, the user can simply remove the whipping cap 120 with the plunger disc 505 attached to the housing 125 from the housing 125 through the threaded connection at the top portion of the housing 125 and also remove the dispensing cap 305 attached to the housing 125 from the housing 125 through the threaded connection at the bottom portion of the housing 125. Then, each the housing 125, dispensing cap 305, whipping cap 120 (with its connected components), and the plunger disc 505 can be easily rinsed, washed, and stored to be available for the next operational use.

The embodiments were chosen and described in order to best explain the principles of the invention and its practical application to thereby enable others skilled in the art to best utilize the invention in various embodiments and with various modifications as are suited to the particular use contemplated.

As various modifications could be made in the construction and method herein described and illustrated without departing from the scope of the invention, it is intended that all matter contained in the foregoing description or shown in the accompanying drawings shall be interpreted as illustrative rather than limiting. For example, the design of whipping and dispensing appliance, nozzle tip designs, and different types of mixing elements and mixing element openings may be employed but can achieve the same functionality of the underlying invention. Thus, the breadth and scope of the present invention should not be limited by any of the above-described example embodiments but should be defined only in accordance with the following claims appended hereto and their equivalents.

What is claimed is:

1. A whipping and dispensing appliance comprising:
a whipping cap;
a storage cap;
a dispensing cap;
a housing, the whipping cap attached to a first end of the housing;
a plunger, the plunger in slidable connection with and through the whipping cap;
at least one mixing element, the at least one mixing element attached to one end of a plunger and insertable into the housing;
a plunger disc, the plunger disc being removably attachable to the at least one mixing element;
wherein in a whipping mode of operation the storage cap is attached to a second end of the housing, and in a dispensing mode of operation the dispensing cap is attached to the second end of the housing; and
wherein in the dispensing mode of operation the plunger disc removably attaches to the at least one mixing element to cover the at least one mixing element, the plunger disc being slidably connected to the plunger through its connection to the at least one mixing element so that movement of the plunger will dispense a food product out of the dispensing cap.

2. The whipping and dispensing appliance of claim 1, wherein the at least one mixing element is a first mixing element and a second mixing element.

3. The whipping and dispensing appliance of claim 2, wherein the first mixing element has a plurality of first mixing element openings.

4. The whipping and dispensing appliance of claim 3, wherein the second mixing element has a plurality of second mixing element openings.

5. The whipping and dispensing appliance of claim 4, wherein the plurality of first mixing element openings are elliptical and the plurality of second mixing element openings are elliptical.

6. The whipping and dispensing appliance of claim 4, wherein the plurality of first mixing element openings are at a first location off set from the plurality of second mixing element openings at a second location.

7. The whipping and dispensing appliance of claim 1, further comprising a second storage cap.

8. The whipping and dispensing appliance of claim 7, wherein the second storage cap is affixed to the top portion of the housing in a storage mode of the whipping and dispensing appliance.

9. The whipping and dispensing appliance of claim 1, wherein the plunger disc includes a wiper, the wiper configured to scrape the whipped food product toward the dispensing cap in the dispensing mode of operation.

10. The whipping and dispensing appliance of claim 1, wherein the dispensing cap includes a nozzle.

11. The whipping and dispensing appliance of claim 10, wherein the nozzle has a nozzle tip with a decorative design.

12. A whipping and dispensing appliance comprising:
a storage cap;
a dispensing cap;
a whipping cap, the whipping cap having an opening through a top surface of the whipping cap;
a seal, the seal being positionally secured upon the top surface of the whipping cap and interchangeable between a first position and a second position, the first position existing when the seal is present within the opening on the top surface of the whipping cap and the second position existing when seal is removed from and not within the opening on the top surface of the whipping cap;
a housing, the whipping cap attached to a first end of the housing;
a plunger, the plunger in slidable connection with and through the whipping cap;
at least one mixing element, the at least one mixing element attached to one end of a plunger and insertable into the housing;
a whipping mode of operation, the whipping mode of operation being operable where the storage cap is attached to a second end of the housing and the seal is located in the first position; and
a dispensing mode of operation, the dispensing mode of operation being operable when the dispensing cap is attached to the second end of the housing and the seal is located in the second position.

13. The whipping and dispensing appliance of claim 12, wherein the whipping cap include an O-ring, the O-ring housed within the whipping cap and in contact with the plunger to remove at least one food ingredient from the plunger in the whipping mode and the dispensing mode of operation when the plunger is slidable through the whipping cap.

14. The whipping and dispensing appliance of claim 12, wherein the seal surrounds the plunger in slidable connection with and through the whipping cap

15. The whipping and dispensing appliance of claim 12, wherein the seal is a circular shape with an extension, the seal and extension securely resting on the top surface of the whipping cap.

16. The whipping and dispensing appliance of claim 15, wherein the seal includes a tab, the tab being graspable by a user to interchange the seal from the first position to the second position.

17. The whipping and dispensing appliance of claim 15, wherein the seal includes a plug.

18. The whipping and dispensing appliance of claim 17, wherein the plug fills the opening on the top surface of the whipping cap in the first position.

19. The whipping and dispensing appliance of claim 18, wherein the plug is removed from the opening on the top surface of the whipping cap in the second position.

20. A method of operating a whipping and dispensing appliance to create a whipped food product, the method comprising:
securing a removable storage cap to a bottom end of a housing, the housing having the bottom end, a top end, and a side wall defining an interior of the housing;
placing at least one food ingredient to be used to create the whipped food product into the interior of the housing;
securing a whipping cap to the top end of the housing, the whipping cap having an opening through a top surface of the whipping cap, a plunger in slidable connection with and through the whipping cap through the opening, the plunger having a first plunger end with a plunger handle attached at the first plunger end and a second plunger end having at least one mixing element attached at the second plunger end, the at least one mixing element being insertable into the interior of the housing to be able to contact the at least one food ingredient;
operating the plunger by way of the plunger handle in a first direction and a second direction to agitate and mix the at least one food product by way of contacting the at least one food product with the at least one mixing element at the second end of the plunger within the interior of the housing until the whipped food product is formed;
removing the whipping cap from the top end of the housing with the plunger connected to the at least one mixing element at the second end of the plunger;
affixing a plunger disc to the at least one mixing element, the plunger disc being removably attachable to the at least one mixing element;
securing the whipping cap to the top end of the housing with the plunger disc attached to the at least one mixing element;
removing the removable storage cap from the bottom end of a housing;
securing a dispensing cap with a nozzle to the bottom end of the housing; and
dispensing the whipped food product by moving the plunger by way of the plunger handle in the first direction to push the whipped food product via the plunger disc towards the nozzle of the dispensing cap and out of the whipping and dispensing appliance.
